(19) United States
(12) Patent Application Publication
(10) Pub. No.: US 2019/0180211 A1
(43) Pub. Date: Jun. 13, 2019

(54) Systems and Methods For Selecting and Transmitting Information and Educational Content

(71) Applicant: BUSINEST PTY LTD, Oakleigh, Victoria (AU)

(72) Inventor: Rhondalynn Korolak, Williams Landing, Victoria (AU)

(21) Appl. No.: 16/063,446

(22) PCT Filed: Dec. 15, 2016
(86) PCT No.: PCT/AU2016/051237

§ 371 Date: Jun. 18, 2018

Related U.S. Application Data
(60) Provisional application No. 62/268,581, filed on Dec. 17, 2015.

(51) Int. Cl. G06Q 10/06; G06Q 40/02; G09B 5/12; G06Q 40/00

(52) U.S. Cl. CPC G06Q 10/06315; G06Q 40/02; G06Q 10/06375; G06Q 40/125; G09B 5/12

(57) ABSTRACT

The present invention provides a computer for providing business-related information to a business entity, the computer comprising: data input means configured to receive financial data of a business entity, a first computer software algorithmic means configured to process financial data of the business entity, the algorithmic means configured to: (i) identify a financial deficiency of the business entity, (ii) identify electronic educational material relevant to the identified financial deficiency, and (iii) instruct the computer, or a separate computer, to transmit electronic educational material relating to the identified financial deficiency to a computer of the business entity. Also provided are means for benchmarking the financial performance of a business entity against a cohort of like businesses in substantially real time.

### FIELD OF THE INVENTION

The present invention relates generally to the field of computer-implemented methods for imparting education and advice. Particularly, but not exclusively, the invention relates to methods and systems for selecting and transmitting information and educational content to a business manager by electronic means.

### BACKGROUND TO THE INVENTION

Many managers of small businesses struggle with understanding the basic financial parameters of their business. In many situations, this lack of understanding can result in the rapid failure of a new business. Even where a business survives the first critical year, the business may fail to reach its full potential in the longer term for similar reasons.

The prior art provides many educational publications which aim to educate business managers of basic financial matters which are important in the day-to-day running of a business, and also longer term operations. Revenues, expenses, assets, liabilities, income statement, balance sheet, and statement of cash flows are topics typically well covered.

Managers of small businesses typically juggle multiple tasks such as financial management, marketing and interacting with clients, and generally have little spare time to fully absorb educational publications. Even where the manager has a complete understanding of the financial parameters of a business, a further difficulty arises in applying the principles learned to his/her own business.

Many managers of small business are also the owner of the business, and therefore may have difficulty in objectively assessing financial parameters. Many business owners ignore impending failure so as to avoid facing personal deficiencies.

Even where a manager is educated in financial matters and can identify deficiencies in the business from the financial data, a further problem is that the manager may not be competent to devise strategies to overcome the deficiency.

Many managers defer to an accountant, business coach or other professional advisor for assistance in running their business. Such professionals typically concentrate on an analysis of the metrics of a business, while others provide only general advice on how a business may be improved. In any event many advisors are not adept at educating a client in financial matters that pertain specifically to his/her business. Thus, the manager becomes dependent on the advisor's advice, which can be expensive.

Even in larger businesses which have dedicated financial staff, managers of smaller business units within may be charged with overseeing the financial health of their unit, and with little assistance. Like small business managers, unit managers may lack the financial education to improve business performance.

While expert professional analysis of a business can be very helpful, the analysis may have little regard as to whether or not a business is performing to its full potential. Many accounting professionals lack detailed information on the industry sector in which their client operates, and so are not able to assess the relative performance of a business.

A further problem in the art is the problem faced by a business manager in locating electronic educational content that is relevant to their business, and particularly locating content which addresses the specific issues facing the business. A vast number of sources of electronic information and education are available via Internet, including a plurality of web pages, streaming video content, streaming audio content, electronic books and brochures. As is typical, a browser-based search engine such as Google™ or Bing™ is implemented by the manager to identify relevant material. Typically, the business manager is forced to trawl through significant amounts of electronic material in order to identify any relevant to a particular business issue. Even where identified by extensive searching, the business manager is often forced to review relevant material amongst a large amount of irrelevant material. Such activities consume a significant amount of time and effort, and can ultimately lead to no benefit. Thus, in one aspect a problem of the prior art may be considered as a technical limitation of existing search engines to identify material which is directly relevant to a business issue for which a business manager requires information or educational content.

A further problem in the art is the ability for a business manager to financially benchmark his/her business against similar businesses. The process of benchmarking typically involves the collection of data from a significant number of similar business. This presents significant technical difficulty for small businesses given that such businesses do not typically make financial data publically available. Even where data is available, it is typically historical in nature and therefore is of limited use to a business manager seeking real-time benchmarking with similar companies. While almost all small businesses retain financial data, such data is not accessible for privacy reasons. However, technical reasons also exist for the lack of access including the use of password protection restricting access to electronic databases, and also the placement of a server hosting an electronic database behind a firewall. Even if a business manager could access similar business financial databases, the data would be in many different formats and therefore technically difficult to process in order to implement benchmarking.

A further problem in the art is the ability for a manager to interpret and act on information relating to sales, marketing, operations, and leadership issues of a business, and to also obtain educational content and information relevant to the business and the current financial situation of the business.

It is an aspect of the present invention to provide improved computer-implemented systems and methods to educate and assist business managers in the running of their businesses by providing means to select and provide educational content and benchmarking data. It is a further aspect to provide an alternative to the prior art.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” or “in some embodiments” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and from different embodiments, as would be understood by those in the art.

In the claims below and the description herein, any one of the terms “comprising”, “comprised of” or “which comprises” is an open term that means including at least the elements/features that follow, but not excluding others. Thus, the term comprising, when used in the claims, should not be interpreted as being limitative to the means or elements or steps listed thereafter. For example, the scope of the expression a method comprising step A and step B should not be limited to methods consisting only of methods A and B. Any one of the terms “including” or “which includes” or “that includes” as used herein is also an open term that also means including at least the elements/features that follow the term, but not excluding others. Thus, “including” is synonymous with and means “comprising”.

Furthermore, it is not represented that all embodiments of the invention disclosed herein have all advantages described. Some embodiments may have only a single advantage, and indeed some may have no advantage merely being a useful alternative to the prior art.

In a first aspect, but not necessarily the broadest aspect, the present invention provides a computer for providing business-related information to a business entity, the computer comprising: data input means configured to receive data from an electronic database comprising financial data of a business entity, a first computer software algorithmic means configured to process financial data of the electronic database, the algorithmic means configured to: (i) identify a financial deficiency of the business entity, (ii) identify electronic educational material relevant to the identified financial deficiency, and (iii) instruct the computer, or a separate computer, to transmit electronic educational material relating to the identified financial deficiency to a computer of the business entity.

In one embodiment of the computer, the first computer software algorithmic means is configured to instruct the computer for providing business-related information to a business entity, or a separate computer, to transmit the financial deficiency identified to the business entity.

In one embodiment of the computer, the first computer software algorithmic means is configured to identify more than one financial deficiency, the algorithmic means is configured to rank the deficiencies according to importance, and without regard to magnitude.

In one embodiment of the computer, where the first computer software algorithmic means identifies more than one financial deficiency, the algorithmic means is configured to rank the deficiencies according to magnitude, and without regard to importance.

In one embodiment of the computer, where the first computer software algorithmic means identifies more than one financial deficiency, the algorithmic means is configured to rank the deficiencies according to importance and magnitude.

In one embodiment of the computer, the first computer software algorithmic means is configured to select one or more electronic educational materials by reference to one or more deficiencies identified.

In one embodiment of the computer, the electronic education material is a document file, and/or an audio file, and/or a video file.

In one embodiment of the computer, the educational material comprises interactive educational material, or directions for accessing interactive educational material.

In one embodiment of the computer, the interactive material is a live seminar, a webinar, a telephone conference, a face-to-face discussion for which personnel of the business entity is permitted to interact with another individual or group of individuals.

In one embodiment of the computer, the educational material is character-based and/or story based.

In one embodiment of the computer, the first computer software algorithmic means is configured to identify a person or an organization suitable to assist the business entity.

In one embodiment of the computer, the data input means is configured to receive data from a plurality of electronic databases comprising financial data of a plurality of business entities.

In one embodiment, the computer comprises data extraction means configured to extract the financial data of similar business entities from the financial data of a plurality of business entities for the purpose of benchmarking.

In one embodiment of the computer, the similar business entities are decided according to one or more of: business entity industry type, business entity location, business entity size, business entity financial data.

In one embodiment, the computer comprises benchmark data calculation means configured to collate the financial data of similar business entities of the plurality of business entities and calculate benchmark data.

In one embodiment, the computer comprises a second computer software algorithmic means configured to compare the financial data of a business entity of the plurality of business entities with the benchmark data.

In one embodiment of the computer, the output of the second computer software algorithmic means is transmitted to a computer of the business entity of the plurality of business entities.

In one embodiment, the computer comprises a third computer software algorithmic means configured to identify a financial deficiency of the business entity of the plurality of business entities by reference to the output of the comparison means.

In one embodiment, the computer comprises a fourth computer software algorithmic means configured to select one or more electronic educational materials by reference to the deficiencies identified by the third computer software algorithmic means.

In one embodiment of the computer, the fourth computer software algorithmic means is configured to identify a person or an organization trainer suitable to assist the business entity.

In a second aspect, the present invention provides a system comprising the computer as described herein in data communication with a computer of a business entity.

In one embodiment of the second aspect, the system comprises the computer as described herein in data communication with a plurality of computers of a plurality of business entities.

In one embodiment of the second aspect, the computer of a business entity is configured to input ancillary information pertinent to a business issue of the business entity, and to transmit the ancillary information to the computer of any one of claims 1 to 11, or to a separate media server.

In a third aspect, the present invention provides a computer-implemented method for providing business-related information to a business entity, the method comprising the steps of: receiving data from an electronic database comprising financial data of a business entity, processing the financial data of the electronic database, the algorithmic means configured to: (i) identify a financial deficiency of the business entity, (ii) identify electronic educational material relevant to the identified financial deficiency, and (ii) instruct the computer, or a separate computer, to transmit electronic educational material relating to the identified financial deficiency to a computer of the business entity.

In one embodiment of the method, the first computer software algorithmic means instructs the computer for providing business-related information to a business entity, or a separate computer, to transmit the financial deficiency identified to the business entity.

In one embodiment of the method, where the first computer software algorithmic means identifies more than one financial deficiency, the algorithmic means ranks the deficiencies according to importance, and without regard to magnitude.

In one embodiment of the method, where the first computer software algorithmic means identifies more than one financial deficiency, the algorithmic means ranks the deficiencies according to magnitude, and without regard to importance.

In one embodiment of the method, where the first computer software algorithmic means identifies more than one financial deficiency, the algorithmic means ranks the deficiencies according to importance and magnitude.

In one embodiment of the method, the first computer software algorithmic means selects one or more electronic educational materials by reference to one or more deficiencies identified.

In one embodiment of the method, the electronic education material is document file, and/or an audio file, and/or a video file.

In one embodiment of the method, the first computer software algorithmic means identifies a training person or a training organization suitable to assist the business entity.

In one embodiment of the method, the data input means is configured to receive data from a plurality of electronic databases comprising financial data of a plurality of business entities.

In one embodiment, the method comprises extracting the financial data of similar business entities from the financial data of a plurality of business entities for the purpose of benchmarking.

In one embodiment of the method, the similar business entities are decided according to one or more of: business entity industry type, business entity location, business entity size, business entity financial data.

In one embodiment the method comprises collating the financial data of similar business entities of the plurality of business entities and calculate benchmark data.

In one embodiment the method, comprises comparing the financial data of a business entity of the plurality of business entities with the benchmark data.

In one embodiment of the method, the output of the second computer software algorithmic means is transmitted to a computer of the business entity of the plurality of business entities.

In one embodiment, the method comprises identifying a financial deficiency of the business entity of the plurality of business entities by reference to the output of the comparison means.

In one embodiment, the method comprises selecting one or more electronic educational materials by reference to the deficiencies identified by the third computer software algorithmic means.

In one embodiment of the method, the fourth computer software algorithmic means identifies a training person or a training organization suitable to assist the business entity.

In one embodiment the method comprises use of the computer as described herein.

In one embodiment, the method comprises use of the system as described herein.

In yet a further aspect, the present invention provides an electronic database comprising a plurality of electronic training material files, the files indexed according to a financial deficiency of a business entity.

In one embodiment, the electronic database is in operable connection with the computer as described herein, or the system as described herein.

A further aspect of the present invention provides computer-executable software embodying any one or more of the first, second, third or fourth algorithmic means as defined herein.

In one embodiment, the computer-executable software is configured to allow a computer to be operable as defined for the computer as described herein.

In one embodiment, the computer-executable software configured to allow a computer to be operable as defined herein.

In one embodiment, the computer-executable software is configured to operate the computer-implemented method as described herein.

### BRIEF DESCRIPTION OF THE DRAWINGS

FIG. 1 shows a flow diagram outlining the sequence of steps and decisions involved in the entry of financial data into a business accounting software package so as to select relevant information or educational content for a business manager.

FIG. 2 shows a flow diagram outlining the sequence of steps and decisions involved in the entry of financial data into a business accounting software package by multiple businesses so as to generate benchmarking data, and then subsequent use of that benchmarking data so as select relevant information or educational content for a business manager.

FIG. 3 is a diagram of a system of the present invention configured to accept financial data from business account software packages of multiple business, and transmission of relevant electronic information or education content to a business manager.

### DETAILED DESCRIPTION OF THE INVENTION

The present invention is predicated at least in part on Applicant's discovery that an electronic database holding financial information on a business is a useful tool in identifying finance-related problems in the business, and furthermore identifying potentially useful educational material for transmission to the business manager. By the present invention, a business manager is provided with customized education which pertains only the deficiencies of his/her business. It is proposed that this targeted education is more readily comprehended by the manager as it is not necessary to fully consider all financial matters of a business as is typical in prior art educational publications.

Accordingly, in a first aspect the present invention provides a computer for providing business-related information to a business entity, the computer comprising: data input means configured to receive data from an electronic database comprising financial data of a business entity, a first computer software algorithmic means configured to process financial data of the electronic database, the algorithmic means configured to: (i) identify a financial deficiency of the business entity, (ii) identify electronic educational material relevant to the identified financial deficiency, and (ii) instruct the computer, or a separate computer, to transmit electronic educational material relating to the identified financial deficiency to a computer of the business entity.

The present invention provides technical means to address a technical problem in the art. As discussed in the Background section herein, a technical problem is faced by a business manager using browser-based search engines to identify educational content or information which may be useful in addressing a deficiency of their business. In one aspect, the present invention addresses that problem by (i) firstly analyze the financial data of the business as entered on a computer of the business entity to identify a deficiency, and (ii) select relevant information from predetermined source(s) of information and content by reference to the stored financial data. The information or content may be selected so as to explain the deficiency to the business manager, and also the strategies and coaching to address the deficiency. This process may be executed automatically by software, such that a business manager is not burdened with the task of data analysis and identifying relevant material to address any deficiency identified.

As will be explained more fully infra, the present invention may derive the financial data from a business accounting software package of the type typically used by small to medium business. The accounting software package may be installed solely on a computer of the business, or more typically present on a server of the accounting package software company. To the best of Applicant's knowledge, the prior art fails to disclose any system whereby financial data retained by an accounting package is analyzed to identify a deficiency in a business and to then select and transmit appropriate educational content or information. In that regard, the database of the business accounting software package is functioning in a new and different manner as compared with the prior art in which raw or processed data is reviewed by the business manager or an external accounting professional.

As used herein, the term “computer” may refer to one computer or to multiple computers which operate in synergy so as to perform the functions required. A computer typically includes a processor (e.g., a CPU, a Graphics Processing Unit (GPU) or both), a main memory, and a static memory, which communicate with each other via a bus. The computer system may further include a video display unit (e.g., a Liquid Crystal Display (LCD). The computer system also includes an alphanumeric input device (e.g., a keyboard), a User Interface (UI) (e.g., GUI) cursor controller (e.g., a mouse), a drive unit, a signal generation device (e.g., a speaker) and a network interface device (e.g., a transmitter).

The computer may be a server which is logically or geographically remote from a computer of the business entity. In that situation, the computer an enterprise-dimensioned server capable of exchanging data with a significant number of client computers.

Alternatively, the computer may be a computer of the business entity in which case the algorithmic means are resident and executable on that computer. In that circumstance, the business entity computer will typically instruct a separate computer (such as a logically or geographically remote enterprise server) to transmit the electronic educational material.

The data input means of the computer may be any means deemed suitable by the skilled person, but is typically a network port. Generally, the network port is connected to a LAN, WAN or the Internet.

The data input means is configured so as receive data from an electronic database of the business requiring the educational material to assist in its business. Preferably, the electronic database is an existing database of the accounting software package used by the business. Accounting packages such as MYOB®, Xero®, QuickBooks®, Reckon® and the like maintain a database of financial data such as income, expenses, accounts receivable, accounts payable etc either on a computer of the business, or on a cloud server. In many embodiments, the accounting software package is operable by the user by way of a browser interface, or a user interface embedded in software on the user's computer. The database of financial data input by the user is stored on a database that may be local (i.e. on the user's computer) or remote (for example on a cloud server of the accounting software package company. Such a database provides a wealth of raw data which may be used to identify a financial deficiency of a business. The use of such databases means that the manager is not required to enter, re-enter or copy data for the purposes of identifying a business deficiency. By this configuration and advantageously, analysis of a business and the transmission of relevant educational material to the manager is devoid of any substantive work by the manager.

The computer will be typically configured (by software means generally, such as an Application Program Interface) so as to import data from an accounting package (optionally automatically), or to accept data exported manually from the software package, or to accept data input via a browser interface or other user interface of the business entity's computer. The computer may be configured (by software means generally) to accept financial data in formats typically utilized by commercial accounting packages or in a common interchange format such as delimited file types such as CSV file, or other formats such as an HTML, XML, XLS or plain text. Alternatively, the data may be ordinarily stored on the computer having been input directly to the computer by a user by way of user interface and in which case there is no requirement for the data to be “accepted” as such.

In some embodiments, the computer having means to accept financial data input is of a business advisory company that either on its own or in combination with the computer of the accounting software package company to identify a deficiency in the finances of a business entity.

With regard to import of financial data, category level data may be used. Account level data, words and phrases and information from what other similar users have done to ‘match’ their chart of accounts intelligently. This significantly reduces manual intervention during import of financial data.

The computer comprises a first software-based algorithmic means configured to accept as input some or all of the financial data of the business entity and to process the data in accordance with a rule or a set of rules to in order to identify a financial deficiency of the business. For example, the algorithm may assess average collection periods by comparing the date at which an invoice is generated to the date at which payment of the invoice is received. The algorithm may identify a deficiency where the average collection period of the business entity is more than 90 days.

More complex aspects of the algorithm may consider multiple variables. As an example, the algorithm may be configured to assess the level of cash at bank over a period of time in conjunction with average debtor amounts over that time period, and to identify a deficiency where an insufficient buffer of funds over the month to account for an unexpected expense over the month.

In some embodiments of the invention, at least 5, 10, 15, 20, 25, 50, 75, 100, 125, 150, 175 or 200 variables are considered in one algorithm, or across multiple algorithms. The multiple algorithms may be interrelated such that the output of one forms at least part of the input of another. A single output may receive output from a number of other algorithms.

Each variable may be a different key performance indicator (KPI) of a business. Preferably, multiple variables are used to select the educational content or information that is transmitted electronically to the business manager. For example, the interrelationship of multiple variables in a single algorithm may be used. As just one form of the invention, income growth may be assessed in relation to growth of debt, debtors, and days to collect receivables. It is proposed that sophisticated and complex analyses of the multiple interrelated variables is capable of providing highly targeted educational content and information to a business manager. Further assistance is provided to the business manager by way of the ranking feature as described elsewhere herein so that educational content on the higher priority issues are presented before that of lower priority issues. For example, fifty deficiencies may be identified, but the top three deficiencies may produce 80% of the benefits to a business.

In some embodiments, a number of outcomes are provided for each scenario tracked. Coaching and step by step instructions for each possible scenario is then transmitted to the business manager. The coaching may relate to sales, marketing, finance, operations or leadership.

An exemplary embodiment involves tracking the relationship between income growth and the growth of receivables (debtors). The following scenarios are possible for this specific KPI and potential deficiency

Receivables Increase Greater than Income Increase

priority of 2 * severity of 2 = ranking of 4
Significance based on receivables as a % of total income

| | |
|---|---|
| Income growth | 5.00% |
| Receivables growth | 20.00% |
| Total receivables | $68,000.00 |
| Total Sales: | $150,000.00 |

The following educational content is transmitted:

| | | valid |
|---|---|---|
| Title | key | key? |
| Buyer Term Negotiation | Receivables/2. Buyer | true |
| Checklist | Term Negotiation | |
| | Checklist.pdf | |
| Credit Application Checklist | Receivables/3. Credit | True |
| | Application Checklist.pdf | |

### Income is Up but Debt is Growing More Rapidly

Your income has increased 5.00% but your debt (money owed to you by customers) is growing more rapidly at 20.00% year to date. This is a serious concern and the reason why start-ups and high growth companies often get into cash flow trouble.
When your business is growing, it's easy to spend too much time focusing on sales, while ignoring the basics of managing your cash flow. With more sales, you can't assume that it will automatically be easier to pay all your debts as they come due. Remember, you cannot pay taxes and bills with cash that you haven't collected yet. It's time to collect your debt and reduce the total amount that is outstanding.

### Show Step-by-Step Instructions

1. Formalize and implement a credit policy—this will help you make fast, accurate decisions about how much credit to extend to each customer. This allows you to invoice sooner and predict when you will actually get paid with greater certainty. You may even choose to ask risky customers for upfront deposits until they establish a track record with you.
2. Analyse your customer base and rank them in categories according to how quickly they pay you. Make a plan to collect everything outstanding more than 30 days.
3. Offer Discounts for quick payment—for example, it is common to allow a 30-day period for payment after the receipt of an invoice. By offering a 2% discount if paid within the first 10 days, you effectively lose 2% of the invoice total and gain 20 days on the availability of the 98% collected. The effective annual interest rate of this is 36.5%—in most cases this will be much higher than your actual cost of capital, so you should not offer this to all customers. However, for chronic late payers who tend to stretch their debts out beyond 90 days, it's an excellent strategy to get money in your bank account quickly.
4. Factor debts—factoring typically involves a third-party, non-bank finance company, that advances a negotiated percentage (75% to 80%), of the receivable (debt owed to you). As the debt is collected by the third party, the advance is paid off, plus a fee to the factor. In some cases, the factor may purchase the accounts at a discount and assume the responsibility and risks of collection.

### Related Resources

Buyer Term Negotiation Checklist pdf
Credit Application Checklist pdf

### Receivables Increase but Income Decrease

priority of 2 * severity of 1 = ranking of 2
Significance based on receivables as a % of total income

| | |
|---|---|
| Income growth | −5.00% |
| Receivables growth | 15.00% |
| Total receivables | $68,000.00 |
| Total Sales | $125,000.00 |

The following educational
content is transmitted

| | | valid |
|---|---|---|
| Title | key | key? |
| Buyer Term Negotiation | Receivables/2. Buyer | true |
| Checklist | Term Negotiation | |
| | Checklist.pdf | |
| Cost of Debt Outstanding > 60 | Receivables/6. Guide | true |
| days | to Calculating the Cost of | |
| | Carrying Debt per day.pdf | |

### Income is Down but Debt is Still Growing

Income over the year to date period has decreased by 5.00% but your debt outstanding to customers has continued to climb by 15.00%. This is a serious risk to your business and a huge drain on your cashflow.
This is a tough situation and you are no doubt feeling a sharp cash flow pinch. Your primary focus this month should be to decrease your outstanding debt, and then to raise sales.

### Show Step-by-Step Instructions

1. Collect all outstanding debt older than 30 days—in order to raise sales and grow your business, you will first need money for marketing and sales activities. That money is currently trapped in your outstanding debt.
2. Factor debts to get cash now—factoring typically involves a third-party, non-bank finance company, that advances a negotiated percentage, 75% to 80%, of the receivable (debt) balance. As the debt is collected by the third party, the advance is paid off, plus a fee to the factor. In some cases, the factor may purchase the accounts at a discount and assume the responsibility and risks of collection.
3. Seek professional help—There may come a point where outsourcing collections is the only sensible option. It costs you on average 11% of the total debt amount to leave it uncollected for 90+ days and you are also 20% more likely to have to write it off completely. A professional is more likely to get results without going to court and will cost you less in the long run.
4. Once you have unlocked some cash by collecting debt, you can then create opportunities to up sell existing customers or find new customers.
5. Focus on existing customers first—it is 6× cheaper and easier to up sell an existing customer than it is to find a new prospect and convert them to a buying customer.

### Related Resources

Buyer Term Negotiation Checklist
Guide to Calculating the Cost of Carrying Debt Per Day
   Given the benefit of the present specification, the skilled person is enabled to identify other suitable algorithms for use in the present invention.

Once a business deficiency is identified, the algorithm is configured to identify educational material relevant to the identified financial deficiency. Thus, by way of algorithmic means, educational material which is specific to the manager's business, and also the problem in the manager's business is identified. Typically, the education material is stored electronically and is indexed according to deficiency. For example, the educational material may be a video which educates about collection periods, and the adverse effects of extended collection periods on business cash flow (and therefore solvency). The video may instruct the manager to shorten collection periods, or to more aggressively pursue late payers. Alternatively, strategies for motivating customers to settle accounts in a timely manner (such as by providing a discount) may be explained in the video.

Thus, upon detection of a deficiency, the algorithm searches the index of electronic educational material to identify one or more materials suitable for transmission to the manager.

The electronic education material may be stored on the computer, or a logically remote computer or a geographically remote computer. In any event, the algorithm transmits an instruction to the computer holding the material to transmit the material to a computer of the business entity for comprehension by the manager. The material may be transmitted by the dispatch of an email having an attached file (such as a PDF or video file) to the business entity computer. Upon receipt, the file is opened and the contents comprehended by the manager.

Alternatively, the email may comprise a link to a remote server with actuation of the link by the manager commencing streaming of an educational video file (for example) to his/her computer. The link may in some circumstances activate a booking for a live webinar, the booking being automatically entered into the manager's electronic calendar (such as Microsoft Outlook®).

In other embodiments, email is not involved and the education material is transmitted to the manager by web-based means when the manager logs into an online account hosted by an accounting software provider, or an online educational organization, for example.

It is possible that the educational material may be transmitted to a mobile device (such as a tablet or a smartphone), and in which case the material may be formatted so as to take account of the limited screen size, audio capabilities, or available memory in such devices.

It will be appreciated that by the present invention the manager of the business entity is not required to consider a wide range of educational material but instead just that material which is pertinent only to an existing problem.

While the present systems and methods utilize the financial data of a business to identify relevant educational material, the educational material may not be strictly directed to financial matters. Material relating to sales, marketing, operations, systems, and leadership (as identified on a consideration of a deficiency of the business) For example, the algorithm may identify a general downward trend in revenue in which case the educational material may relate to strategies for leading and motivating a group of sales persons. As another example, the algorithm may identify that a significant number of credit notes are issued, which indicates an unacceptably high level of product returns. In that case the educational material may be directed to matters of quality control, or to improving the description of a product on a website for example to allow a customer to better select the product appropriate to his/her needs.

In some embodiments, the educational material is simplified and avoids common financial jargon and complex cash-flow scenarios. Thus, in these embodiments, the educational material comprises presentation of a simplified version of the business entity's financial position based on an algorithmic analysis or a transformation of the entity's raw financial data. For example, the financial position of the business entity may be reduced to a simplified “money-in, money out” scenario which is readily comprehensible by the manager and therefore useful as a base from which remedial strategies may be proposed and executed.

To improve comprehension of the educational material, various neuroscientific techniques may be exploited. As just one example, character-based animations may be used to explain financial concepts. One human-based character of the animation may be prone to spending, and another may be prone to saving money with the interaction between the characters being illustrative of the financial inputs and outputs of a business.

The educational material may comprise specific advice based on the identified deficiency. In some embodiments the education material comprises an interactive component, or means for directing the manager to an interactive component. As used herein the term “interactive component” is intended to distinguish from static material such as set text or a set video. For example, the interactive component may be a live webinar event with a question and answer facility such as GoToWebinar® (Citrix Systems), allowing the manager to interact with the presenter and also other webinar participants. A manager may be directed to a webinar by a hyperlink in an email or a PDF document, for example.

The interactive component of the educational material may take the form of a telephone conference between a private business coach and the manager. In that circumstance, the manager is directed to the interactive component by an email or a SMS text message to the manager's smartphone reciting the coach's telephone number or address.

Given the benefit of the present specification the skilled person is able to conceive of other electronic means for directing a manager to an interactive component, all such means included in the ambit of the present invention.

In some embodiments, the first algorithm is configured to monitor whether any deficiency remains unresolved, or is improved, or exacerbates over time. Where the deficiency remains unresolved or exacerbates overtime, more intensive education material may be transmitted to the business entity in an effort to reinforce or further the teaching of the material transmitted initially. For example, where extended collection periods remain unresolved, the educational material may impart advanced techniques shown to improve collection times. The further material may comprise suggested time tables for contacting a customer, suggested text for reminder letters or suggested scripts for telephone calls.

Where the deficiency is improved or completely resolved, the first algorithm may be configured to transmit an electronic reward to the manager. The reward may simply comprise an encouraging email, or provide a more tangible reward such as a discount voucher for personalized business coaching or similar.

Many businesses will have multiple deficiencies which become apparent upon execution of the first algorithm. Accordingly, the first algorithm may be configured so as to rank the deficiencies according to importance and/or magnitude. Examples of important deficiencies are those which can lead to insolvency, the loss of an important supplier, the loss of an important customer, the loss of an important employee, the inability to pay tax on time, substantially overdrawing on a business credit facility, impending default on a business loan, and the like. Parameters than may be indicative of such outcomes include extended periods of low or negative cash reserves, increasing debts to an important supplier, increasing collection periods from an important customer and the like.

The first algorithm may be configured so as to automatically classify a supplier as important based on average purchases over time, as a percentage of all purchasers. Similarly, a customer might be automatically classified as important based on average sales over time, as a percentage of all sales.

In some instances, a deficiency may be important (in an absolute sense, and having regard to sound business operation practices) but the magnitude of the deficiency is small. In such cases, the ranking may be modified by reference to the magnitude of the deficiency. For example, an average 20% increase in average collection period would normally be considered as important, however since the total amount of receivables outstanding was a very small amount (say 5 or 10% of total sales), then the deficiency would be ranked lower because there is no material risk to the business.

Upon ranking, at least one of the low-ranking deficiencies may be ignored such that a smaller number of deficiencies may be highlighted to the manager. For example, while the first algorithm may identify 10 deficiencies, the 7 lower ranked deficiencies may be ignored such that such that educational on only the top 3 ranked deficiencies is transmitted to the business entity computer. Advantageously, the manager is not faced with the prospect to needing to review large amounts of educational material.

As the higher-ranked deficiencies are resolved overtime, the previously lower-ranked deficiencies become higher-ranked, and so the computer transmits educational material on those previously lower-ranked deficiencies to the manager. Advantageously, the manger is able to address deficiencies in a serial manner, and in order of combined importance and magnitude. This provides a manageable learning environment for the manager and prevents presenting the manager with an overwhelming amount of correction work to be executed.

An exemplary embodiment involves scoring for a particular scenario with a number of different possible outcomes. The lower the overall ranking (combined with significance), the more likely it is to appear high on a list of deficiencies presented to a business manager.

### Receivables Increase but Income Decrease

priority of 2 * severity of 1 = ranking of 2
Significance = 1 (measured by receivables as a % of total sales
(57% in this case which is significant))

| | |
|---|---|
| Income growth | −5.00% |
| Receivables growth | 15.00% |
| Total receivables | $68,000.00 |
| Total sales | $120,000.00 |

Receivables Increase Greater than Income Increase

priority of 2 * severity of 2 = ranking of 4
Significance = 2 (measured by receivables as a % of total sales
(45% in this case which is moderately significant))

| | |
|---|---|
| Income growth | 5.00% |
| Receivables growth | 20.00% |
| Total receivables | $68,000.00 |
| Total sales | 150,000.00 |

### Receivables Decrease and Income Decrease

priority of 2 * severity of 3 = ranking of 6
Significance = 2 (measured by receivables as a % of total sales
(50% in this case which is moderately significant))

| | |
|---|---|
| Income growth | −10.00% |
| Receivables growth | −2.00% |
| Total receivables | $50,000.00 |
| Total sales | $100,000.00 |

Receivables Increase Less than Income Increase

priority of 3 * severity of 4 = ranking of 12
Significance = 3 (measured by receivables as a % of total sales
(30% in this case which is somewhat significant))

| | |
|---|---|
| Income growth | 15.00% |
| Receivables growth | 5.00% |
| Total receivables | $45,000.00 |
| Total sales | $150,000.00 |

In some embodiments, the first algorithm is configured to assess whether or not the business entity is likely to benefit also from external assistance. Accordingly, in addition to educational material the computer may be configured to identify a previously indexed suitable person or an organization to assist in addressing the deficiencies identified. The person or organization may be indexed according to expertise, industry experience, and the like, with contact details of each person or organization stored electronically or the computer of a separate computer. For example, where the first algorithm identifies a significant number of important deficiencies and most of which are of a significant magnitude then it is likely that the manager will benefit from rapid and personalized mentoring with the aim of overcoming the deficiencies as quickly as possible so as to prevent the irrevocable failure of the business.

The assistance may be provided the manager physically meeting with the person or personnel of the organization, or virtually by way of Skype® or similar facility. The computer may be configured so as to transmit relevant financial data of the business entity to the person or organization assisting.

While the above embodiments of the invention are useful in assisting managers in operating a small business, there is the further issue of assessing whether or not the business is operating as well as could be expected in all the circumstances. Thus, while a business entity may, upon analysis by the first algorithm, have no deficiencies or only minor deficiencies, the question remains as to whether further improvement is possible.

In accordance with a preferred embodiment of the invention, the computer is configured (generally by software means) to utilize the financial data of a plurality of business entities in order to provide benchmarking data against which the financial data of a single business entity may be compared. Accordingly, the computer may be configured so as to receive data from a plurality of business entities. Typically, each of the computers of all business entities will be in data communication with the present computer via Internet connection. Thus, the present computer is continually in receipt of new data sets reflecting the changing financial parameters of each business, and the financial parameters of new business entities providing datasets to the computer for the first time.

To the best of Applicant's knowledge, the prior art is silent to the use of business accounting software package to obtain the financial data from a plurality of non-related businesses for use in a benchmarking exercise. Thus, the prior art is devoid of any system whereby financial data is uploaded to a business software package, and where the collated information from a plurality of non-related businesses is stored in the database and used in a benchmarking exercise.

As used herein, the term “unrelated” is intended to refer to businesses that do not have a common owner, or a common operator, or a common accountant, or a common business advisor. In the prior art, business entities have been benchmarked against each other where they are part of the same store chain, or franchise for example. The present benchmarking is distinct from such prior art benchmarking given that the business entities of the present invention would have no other means of comparing financial data in a live scenario.

While the present computer may provide benchmarking data taking into account the datasets of all business entities, greater advantage is provided whereby a subset of the all data is used. It is more instructive for a business entity to benchmark its performance against similar businesses. The similarity of any two business may be decided by any useful parameter, which may include business entity type. Business entity type may be classified broadly (such as retail), more particularly (such as clothing retail), still more particularly (such as female clothing retail) or very particularly (such as teenage female clothing retail).

Where sufficient datasets are available so as to provide useful benchmarking data, the preference will be to compare only very similar businesses (for example, teenage female clothing retail businesses). Where insufficient datasets are available, less particular benchmarking data may be used (for example, comparing a teenage female clothing business entity against benchmarking data collated from all retail clothing businesses). Where accounting software packages provides the datasets it may be necessary for the manager to manually transmit that information given that existing packages do not typically record that information.

Another criteria for categorizing business entities as similar includes business location. Again, as required the location may be broadly defined (for example, Canada) through to very particularly (for example the central business district of Vancouver). Location information may be obtained automatically by reference to the IP address of the business entity computer providing the dataset.

Businesses may be further categorized quantitatively by parameters such as employee number, number of branch stores, turnover, number of products sold annually, and the like. Comparison on the basis of performance parameters such as turnover or number or products sold is less desired so as to avoid only comparing a low performing company with a group of other low performing companies and incorrectly concluding that the low performing company is operating well according to benchmark data.

The categorization of a business entity providing a dataset may be decided automatically by algorithmic means, however more typically non-algorithmic means are used given the simplicity of each business entity providing the required information. For example, when logging in to a user interface of the present computer, the user may be required to complete a guided questionnaire which accurate categorizes the business entities across a range of parameters. A manager may update the information due to employee numbers, an expansion in business activities, geographical relocation and the like.

The second algorithmic means of the computer is configured so as to compare a business entity according to a benchmark. The algorithm may be configured to automatically select the datasets against which the business entity is compared, based on a previously determined category, sub-category, sub-sub-category etc. as described above. Where insufficient datasets exist so as to prevent a meaningful benchmark from being calculated, datasets from a broader benchmarking category, or a related category may be automatically selected by the algorithm.

In some instances, a related data category may provide a useful comparison. For example, a comparison between a first business retailing golf sporting goods and a second business involved in golf tuition in a particular geographical area may be useful to ascertain whether the retail business is tracking an increase in the service business.

The output of the second algorithmic means (being the benchmark comparison of a business entity) may take any useful form, but is typically expressed in graphical form designed to quickly show whether a business is superior, inferior, or average according to benchmark and furthermore how far removed a business is from any benchmark.

Suitable parameters for comparison include revenue, turnover, profit/loss, sales growth over time, average cash at bank, average collection time, average employee salary (calculated by division of all wages paid by the number of employees), average amount of accounts payable, expenses (and possibly divided into categories such as consumables, travel, advisors etc) and the like. Such comparative information allows a manager to compare his/her business against similar businesses and identify areas for improvement so as to approach a benchmark.

Typically, the datasets are anonymized upon input to the server so as to present any party from ascribing any particular dataset to any particular business entity.

In one embodiment, the computer is configured so as regularly update benchmarking data. This may be achieved by regularly and automatically extracting datasets from the plurality of business entity computers, or by prompting manager to voluntarily upload a recent dataset. Advantageously, this embodiment provides current data to a manager. Business conditions can alter rapidly and unexpectedly and current information may be important for a manager to decide whether or not his/her business is performing according to a benchmark. As an example, an unexpected succession of hot days toward the end of spring may stimulate shoppers to purchase new supplies of summer clothing leading to a spike in retail sales. In isolation, a retailer may consider that an increase of 20% in sales is pleasing however the benchmark of similar stores may reveal and average increase of 50% in which case the retailer may reconfigure advertising strategy so as not lose any further market share.

Prior art methods of benchmarking typically rely on historical datasets which do not reflect current trading conditions or large numbers of identical businesses (for example, 200 Subway™ franchises). The present invention is a significant advance on the prior art by providing potentially very large datasets derived from similar business (, for example 1000 independently owned and operated fast food restaurants), the benchmark data produced being virtually live.

It will be appreciated that more accurate benchmarking data will be provided with financial data from a greater number of business entities. In some embodiments, the datasets comprise financial data input by at least about 100, 200, 300, 400, 500, 600, 700, 800, 900, 1000, 1500, 2000, 2500, 3000, 3500, 4000, 4500, 5000, 6000, 7000, 8000, 9000, 10000, 15000, 20000, 25000, 30000, 35000, 40000, 45000 or 50000 business entities. Where the benchmarking is for the purposes of comparing very closely related businesses (for example, the members of a single franchise) a lower number participating business entities (such as between 25 and 100) may be required so as to provide a benchmarking data.

In some embodiments, the computer comprises a third computer software algorithmic means configured to identify a financial deficiency of a business entity by comparison with benchmarking data. The algorithm is configured so as to identify any parameter that is significantly inferior, and to select and transmit appropriate educational material to the business entity computer. Taking the example described above, where the third algorithmic means identified a lost opportunity in retail clothing sales during a period of unexpected hot weather, the algorithm may search the index of educational materials to identify material imparting strategies to maintaining or even growing market share during times of market expansion. For example, strategies such as doubling direct offers or marketing to existing customers as a method to lift sales quickly, profitably and cost effectively.

It will be appreciated that in some circumstances, a manager may not require any algorithmic analysis of his/her financial parameters against a pool of like businesses, and instead wishes to only review a benchmarked comparison. Such embodiments are included in the ambit of the present invention.

The fourth algorithm may further identify a previously indexed person or organization suitable for assisting the manager to rectify the deficiency identified by benchmarking. In the above example, the algorithm may identify a person indexed as having experience in advertising high volume retail clothing sales.

The present computer may be further configured so as to be in data communication with the computer of a third party advisor of the business entity. The present computer may be configured to transmit any financial data or the business entity, any deficiency identified by computer, any analysis or transformation of the financial data performed by the computer, or any educational material to a third party advisor computer. By this embodiment, an advisor (such as an accountant, mentor, business coach, bookkeeper, or franchisor) is kept up to date with the overall financial health of the business entity, and the strategies under implementation to overcome any deficiency identified, and also any success or failure of the strategies. The data communication may be by way of email (for example, the computer transmitting an email to the advisor) or by the advisor having access rights (by way of secure log in for example) to the computer, and in particular the business entity's account on that computer. The material accessible by the advisor may be less simplified or more complete than that provided to the manager given the higher level of financial literacy of the advisor.

In some embodiments, the computer is configured to alert an advisor as to which of his/her clients has a significant deficiency identified (based on actual historical data or forecasted data, for example), thereby allowing the advisor to directly access the relevant materials (raw financial data, simplified or processed financial data, educational material, strategies implemented etc.) with a view to provide urgent assistance. The alert may be by way of direct email or SMS text message or electronic push notification. Alternatively, upon logging into the computer the advisor may be presented with a list of clients having had significant deficiencies identified, with the advisor capable of directly viewing the client's relevant material by selecting that client.

Alternatively, the computer is configured to transmit an alert to the business manager. The alert may highlight a financial deficiency and optionally make reference to educational material which may be helpful. Push notifications may be sent to the business manager as follow up to the original alerts.

Alerts (including push notifications) may be forwarded from a computer of a business advisory company either in its capacity as the computer in receipt of the financial data or as a computer in network connection with the computer in receipt of the financial data.

Other embodiments of the computer provide a configuration by which a manager may transmit information on which strategies to overcome a deficiency are being implemented, from a business entity computer to the subject computer. In some embodiments, the information is transmitted verbally (for example by telephone) from the manager to an individual associated with the computer (such as an employee of an account package software company), with the information being subsequently manually input into the computer by the individual. Once in receipt of the information relating to strategies, the computer may be configured so as to cease monitoring (at least for some time) one or more deficiencies for which strategies are not currently being implemented. For example, where the algorithm identifies low sales and slow collections as two deficiencies the manager may elect to address only the issue of low sales. In that situation the computer is configured so as to not transmit any further educational material relating to slow collections thereby allowing the manager to focus in the short term on improving sales.

Thus, in respect to the embodiments immediately supra, the business entity computer may be configured so as to receive ancillary information from a user and to transmit that information to a computer configured to receive the ancillary information and generate an appropriate instruction or message. The receiving computer may be that of an allied company, or in some cases the accounting software package company computer. The ancillary information input by the user (typically a business manager) may relate to the specific deficiencies being addressed, and in which case the information may comprise a request to receive more detailed education content, information or coaching on a particular business issue. As one example, the business manager may be addressing a cash flow deficiency, and may input a request for more detailed information on how to shorten collection times. The user request may be unrelated to any deficiency identified by an algorithm of the present invention, and may pertain to a non-financial business issue (such as leadership, dealing with absenteeism in the workplace, or employment contracts) or to a future financial issue (such as a predicted decrease in cash at bank due to upcoming capital expenditure of the business).

The ancillary information may be input in the form of free text, in which case a search-based algorithm of the type well known to skilled artisans may be implemented (typically executed by the computer receiving the ancillary information) to identify related education content or information for transmission to the user. In other embodiments, the ancillary information may be provided by way of selection of a topic from a menu of predefined topics.

Menus (including cascading menus) may assist the user to define the issue for which additional content is required. Other selection means such as radio buttons, guided questionnaires and the like may also be utilized.

The ancillary information by a computer may cause that computer to instruct a separate media server to transmit relevant educational content to the user. Alternatively, the ancillary information may be transmitted to a computer of media server with there being no involvement of a third computer.

In some embodiments, the ancillary information may be used in combination with any identified deficiency so as to improve the relevance of educational content or information transmitted to the user. In one example, the user may request information relating to absenteeism in the workplace, and the business entity has an identified deficiency in cash flow. The computer in receipt of the ancillary information (which in this context or any other context may be a computer of an allied business advisory company) may identify content highlighting the negative effects of absenteeism on cash flow, and how to (i) reduce absenteeism and (ii) mitigate cash flow problems where the absenteeism is unavoidable. The user may not have even considered that the two parameters were conceptually linked, and the algorithmic analysis of the business entity financial data could not have identified absenteeism as a probable cause of the cash flow problem.

The ancillary information may be reviewed by a human (such as a person associated with an allied business advisory company), and where relevant educational material is not part of the predetermined set available for transmission, the human may be prompted to generate the relevant educational material. This material will then form part of the predetermined bank of educational content and information for transmission to a business manager.

A further aspect of the present invention provides a system comprising a computer as described herein. The system may comprise the present computer (acting as a server computer) in data communication with a business entity computer (acting as a client computer). More typically, the computer will be part of a networked system of a large number of client computers, as required to provide a sufficient number of datasets for meaningful benchmarking data to be generated. Exemplary means for networking computers are disclosed more fully herein infra.

The system may comprise further computers in data communication with the first computer, such as a plurality of business entities participating in benchmarking aspects of the invention, or third party advisors of a business entity.

A further aspect of the present invention provides computer implemented methods for providing business-related information to a business entity, the method comprising the steps of: receiving data from an electronic database comprising financial data of a business entity, processing the financial data of the electronic database, the algorithmic means configured to: (i) identify a financial deficiency of the business entity, (ii) identify electronic educational material relevant to the identified financial deficiency, and (ii) instruct the computer, or a separate computer, to transmit electronic educational material relating to the identified financial deficiency to a computer of the business entity.

Further features of the methods, and advantages of those features, are broadly in line with the features and advantages described supra as for the present computer. For the purposes of clarity and conciseness of the specification such features and advantages recited supra are incorporated herein by reference. As discussed elsewhere herein, the methods may be implemented by software executed on a single computer or across multiple computers.

In some embodiments (and particularly the embodiments involving means for benchmarking the performance of business entity) the method comprises receiving data from a plurality of business entity computers. Furthermore, the method comprise the steps of benchmarking as broadly defined herein supra, in reference to the computer. For the purposes of clarity and conciseness of the specification such process steps and advantages recited supra are incorporated herein by reference.

A further aspect of the present invention comprises computer-executable software written so as to be operable in the context of the computer, system or methods described herein. As indicated to supra, various components of the invention are provided as computer-executable software components. These components, and the functionality associated with each, may be used by client, server, or peer computer systems. These various components can be implemented into the system on an as-needed basis. These components may be written in an object-oriented computer language such that a component oriented or object-oriented programming technique can be implemented using a Visual Component Library (VCL), Component Library for Cross Platform (CLX), Java Beans (JB), Enterprise Java Beans (EJB), Component Object Model (COM), or Distributed Component Object Model (DCOM)), or other suitable technique. These components are linked to other components via various APIs and then compiled into one complete server and/or client application. The method for using components in the building of client and server applications is well known in the art. Further, these components may be linked together via various distributed programming protocols as distributed computing components.

Where the software may be embodied in the form of a “machine readable medium”. This term should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies illustrated herein. The term “machine-readable medium” shall accordingly be taken to include, but not be limited to, solid-state memories, optical and magnetic media, and carrier wave signals.

In one embodiment the software is embodied in the form of business accounting software of the type well known to the skilled artisan, or configured so as to import data from business accounting software. Exemplary forms of such software include MYOB®, Xero®, QuickBooks®, and Reckon®. Thus such existing accounting software can be adapted or augmented to exploit the computers, systems or methods described herein. For example, an accounting software company may adapt existing accounting software such that upon installation in a client computer a data connection if formed with a computer server (which is configured as a computer configured as described herein) of the software company. In such embodiments, the importing any importing of financial data to the computer server is automatic and seamless. The software may be further adapted so as to accept non-accounting software data by way of user interface to allow input of data such as location of the business entity, number of employees, general industry area and the like as required for benchmarking embodiments of the invention. The adaptation may extend to the provision of media players and document viewers so as to facilitate transmission of education material and benchmarking analysis to the manager.

Some embodiments of the invention may require distributed computing components and protocols. An embodiment may include remote procedure calls being used to implement one or more of the above-illustrated components across a distributed programming environment. For example, a logic level may reside on a first computer system that is located remotely from a second computer system including an interface level (e.g., a GUI). These first and second computer systems can be configured in a server-client, peer-to-peer, or some other configuration. The various levels can be written using the above-illustrated component design principles and can be written in the same programming language or in different programming languages. Various protocols may be implemented to enable these various levels and the components included therein to communicate regardless of the programming language used to write these components. For example, an operation written in C++ using Common Object Request Broker Architecture (CORBA) or Simple Object Access Protocol (SOAP) can communicate with another remote module written in Java™. Suitable protocols include SOAP, CORBA, and other protocols well-known in the art.

As described herein, some embodiments may require the transmission of data between two computers such as a server and a client. Some embodiments may utilize the Open Systems Interconnection (OSI) model or Transmission Control Protocol (TCP)/IP protocol stack model for defining the protocols used by a network to transmit data. In applying these models, a system of data transmission between a server and client, or between peer computer systems, may comprise a series of layers comprising: an application layer, a transport layer, a network layer, a data link layer, and a physical layer. In the case of software having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also includes port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an Internet, LAN, WAN, or some other suitable network. These networks may use a variety of protocols for the exchange of data, including the aforementioned TCP/IP, or some other suitable protocol. These networks may be organized within a variety of topologies (e.g., a star topology) or structures.

Where the invention is embodied in the form of a computer or a computer system, this may comprise a machine that executes a set of instructions to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment or as a peer machine in a peer-to-peer (or distributed) network environment. The machine may be a Personal Computer (PC), a tablet PC, a PDA, a cellular telephone, a Web appliance, a network router, switch or bridge, or any machine capable of executing a set of instructions (sequential or otherwise) that specify actions to be taken by that machine. Further, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems, which are linked (e.g., either by hardwired, wireless, or a combination of hardwired and wireless connections) through a network, both perform tasks such as those illustrated in the above description.

The computer will typically comprise a disk drive unit including a machine-readable medium on which is stored one or more sets of instructions and data structures (e.g., software) embodying or used by any one or more of the methodologies or functions illustrated herein. The software instructions may also reside, completely or at least partially, within the main memory and/or within the processor during execution thereof by the computer system, the main memory and the processor also constituting machine-readable media.

The instructions may further be transmitted or received over a network via a network interface device using any one of a number of well-known transfer protocols (e.g., Hyper Text Transfer Protocol (HTTP), Secure Hyper Text Transfer Protocol (HTTPS)).

The present invention will now be more fully described by reference to the following non-limiting embodiments.

### Preferred Embodiments of the Invention

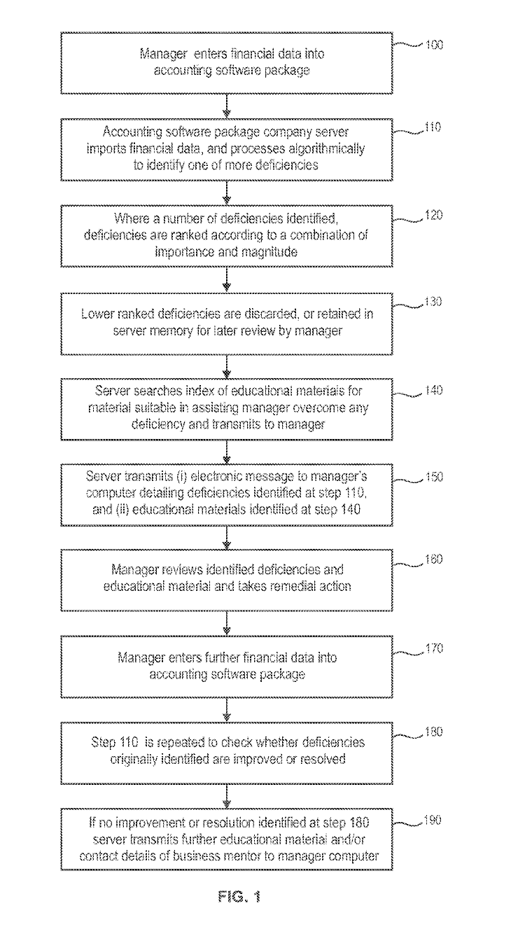

FIG. 1 shows process steps of a preferred embodiment of the invention, detailing the transmission and processing of information between a computer of a business entity manager and a server of an accounting software company. At step 100 the manager (or an accounts clerk of the business entity) continuously enters all the usual financial data of a business into an accounting software package installed on a business entity computer. Alternatively, the data may be entered into a user interface (such as a browser interface) which is not part of an accounting software package installed on a business entity computer. In the alternative embodiment, the data is uploaded directly to a cloud server of an accounting software package company. Such data includes sales, expenses, customer payments, refunds, tax paid, invoices payable and the like. This data is used by the software package for all the usual tasks performed by an accounting software package such as generation of reports such as profit/loss statements, generation and transmission of invoices to customers, calculation of taxes and the like. For these purposes, the financial data is input via a user interface of the business entity computer, and then stored on a cloud server operated by the accounting software company.

The business entity computer has a secure data connection (via the Internet) with a server administered by the company which produces the accounting software. At step 110 the server is configured to accept uploaded financial data from the business entity computer (the upload being via the internet and to a cloud server), and then via any one or more of the algorithmic means disclosed herein identify a deficiency in the financial data. The deficiencies are then ranked at step 120, and lower-ranked deficiencies discarded 130. Alternatively, the lower ranked deficiencies may be retain in server memory to be considered by the business entity manage at a later date, and when more pressing deficiencies have been addressed.

The server holds a library of electronic business educational material, which comprises video files and document files. The material is indexed on the server so as to be selectable as potentially relevant according to a deficiency which is identifiable by the algorithmic means at step 110. For example, a video may contain material relevant to the problem of cash flow and may be indexed as such with the keyword “cash flow”. The same video may also be indexed according to any of the various causes of poor cash flow, such as “collections”, “cheque clearance”, and “timing of travel expenditure”. Accordingly, this video will be relevant to several problems with the interactions between those problems being instructive to the manager.

At step 140, server software selects (via the index) one or more educational videos which will assist the manager in not only understanding the deficiency, but also possible means by which it may be overcome.

At step 150 the server transmits a document to the business manager via email detailing the deficiencies identified in the business. This document (which may be a PDF) is constructed automatically by software on the server from a library of text documents stored on the server. For example, the document may be constructed from text which is descriptive of 3 discrete business problems which were identified by analysis by the algorithms encoded in the server software.

The document transmitted to the manager comprises hyperlinks which (upon actuation) commence streaming of relevant video educational material to the manager's computer. The videos are those identified at step 140.

At step 160 the manager reviews the educational content, and then takes the action suggested to overcome a deficiency. For example, where the deficiency is slow collection from customers, the manager may alter invoice text to offer a 5% discount if the invoice is settled within a stipulated period. The manager may also instruct the accounts clerk to forward reminder emails to customers on a more frequent basis in an effort to minimize late settlement.

The activities of the business entity continue on as usual with all the usual financial data being entered into the computer software package day-by-day. Over the next month, the server imports further financial data of the business entity and repeats the algorithmic analysis of step 110, although this time with the financial further data. The aim of step 180 is to ascertain whether or not there has been any improvement in a deficiency identified at step 110. For example, where the deficiency is low cash flow due to slow collections a decrease in collection period from say, 45 days to 35 days, may be indicative that (i) the educational material chosen was relevant and (ii) the manager acted on the advice contained in the educational content.

Where the collection period has not improved, this is identified by the server software at step 190 and the server then transmits further educational material to the business entity manager. The further material may be highly instructive video material detailed more advanced techniques to reduce collection periods. The further material may sample letters (attached as Microsoft Word® document to an email transmitted to the manager) demanding payment.

In the preferred embodiment describe above, it will be appreciated that the server may be administered by a third party company completely separate to the accounting software package company. The third party company may provide software for installation on the business entity computer configured to extract financial data from the accounting software package database stored locally in the business entity computer. More typically, the financial data is extracted from cloud storage means which may be hosted by accounting software package company or a third party.

In some embodiments, the cloud storage means is hosted by the accounting software package company and the analysis of the financial data if effected by cloud computing means.

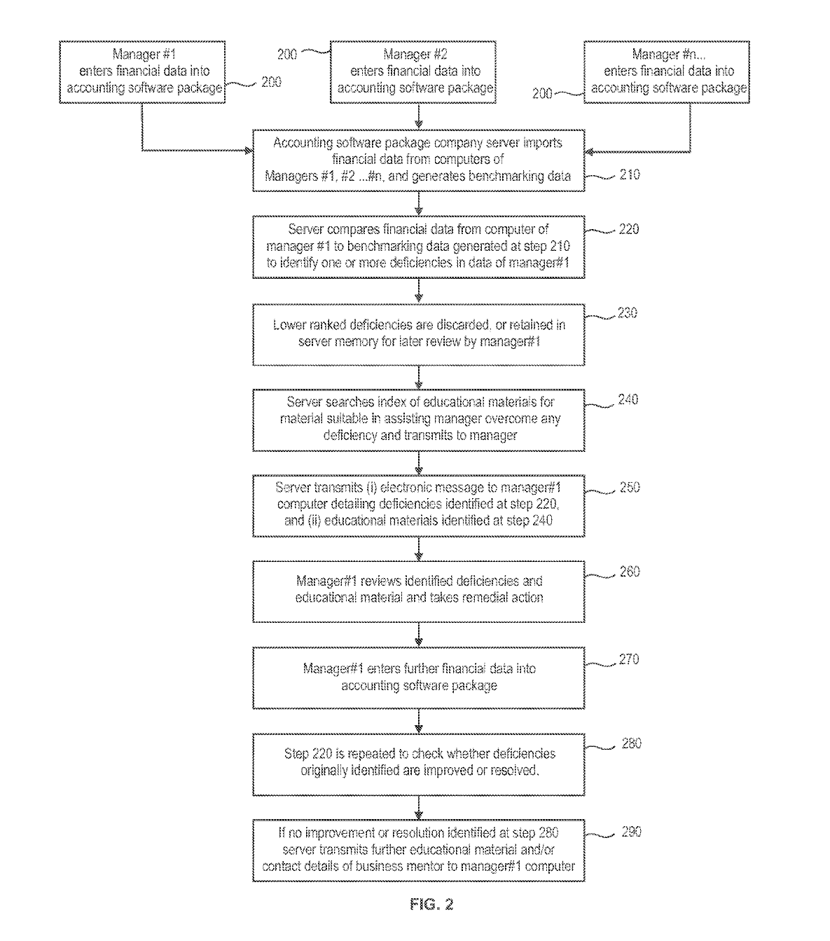

Turning now to FIG. 2 there is shown the process steps involved in embodiment of the invention which provide benchmarking data, and furthermore exploits that data to identify further deficiencies in a business entity's performance.

As will be appreciated from the figure, this embodiment requires the input of financial data from a plurality of business entities 200. In the same manner as for the embodiment of FIG. 1 the server of an accounting software company (or an allied business advisory company) accepts the data entered by the entities 210. Peculiar to this embodiment, the data are used to generate benchmarking data. In selecting datasets for the generation of benchmark data, the server software may collate financial data only from similar companies. The criteria for similarity may be set algorithmically by server software so as to best identify relevant benchmarks with any deficiencies being fairly considered capable of being overcome by Manger#1. There would be little point in seeking to identify deficiencies in the profitability of a single take-away food store by comparison with a business having 10 take-away food stores. For example, Manager#1 may require benchmarking of his/her plumbing business against (i) all plumbing businesses in the same city, and also (ii) plumbing businesses operating only in the inner suburbs.

Once a deficiency in performance is identified, then similar process steps to those following such identification in FIG. 1 are carried out (being steps 230, 240, 250, 260, 270, 280 and 290 of FIG. 2)

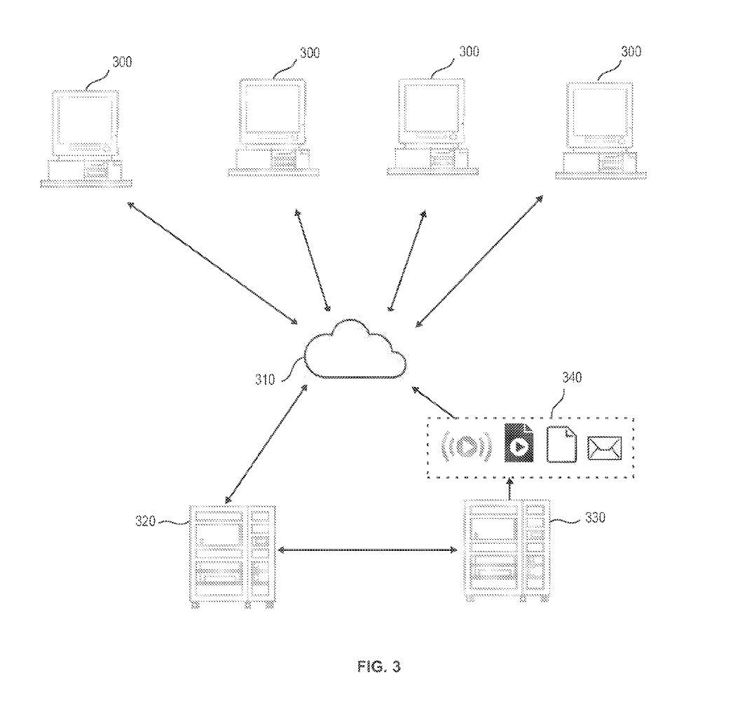

With regards to a preferred hardware configuration of the present invention, reference is made to FIG. 3 which shows a computer network operable according to the embodiment of FIG. 2. Multiple computers 300, each of a single and discrete business entity are shown. In reality, the number of computers is likely to be in the hundreds, or thousands so as to provide sufficient financial data for benchmarking. Each computer 300 has a user interface for an accounting software package configured to allow input financial data of the business entity. The input may be achieved manually, or via some electronic import means from other databases of the business entity. Typically, the financial data is uploaded via a secure connection via the Internet 310 to a server 320 of the accounting software package company. The server 320 comprises means for receiving and storing the financial data uploaded from computers 300.

The server 320 comprises software configured to identify a deficiency in the financial data imported from any single computer 300 by reference to a set of rules embodied in a software algorithm held by the server 320. Where a deficiency is noted, software of the server 320 searches a library index on a separate media server 330 to identify relevant educational material stored on the media server 330. The server 320 instructs the media server 330 to transmit educational material 340 (being streaming video, and/or a video file, and/or a document file and/or an email) to any one of the computers 300.

As will be apparent from the above, the present invention may involve the use of processors, (including microprocessors), software executable on such devices and the like to control one or more motors and/or to received sensor data and/or to process sensed data. Some methods may be computer executable. Moreover, systems may be required interconnect components such as processors, motors, sensors and the like.

Application software useful in the context of the present invention may be executable on any past, present or future operating system of a processor-enabled device including Android™, iOS™, Windows™, Linux™ and the like. Where the business entity computer acts only as a user interface for the user to upload financial data to a cloud-based accounting package, the primary software is in the form of a web browser such as Microsoft Edge™, or Mozilla Firefox™.

The methods and systems described herein may be deployed in part or in whole through one or more processors that execute computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a coprocessor (math co-processor, graphic co-processor, communication co-processor and the like) and the like that may directly or indirectly facilitate execution of program code or program instructions stored thereon. In addition, the processor may enable execution of multiple programs, threads, and codes.

The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere.

Any processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through one or more computers that execute software. The computer may include one or more of memories, processors, computer readable media, storage media, ports (physical and virtual), communication devices, and interfaces capable of accessing other computers, and devices through a wired or a wireless medium, and the like. The methods, programs or codes as described herein and elsewhere may be executed by the computer. In addition, other devices required for execution of methods as described herein.

Methods, programs codes, calculations, algorithms and instructions useful in relation to the present invention may be implemented on or through mobile devices. The mobile devices may include navigation devices, cell phones, mobile phones, smart phones, mobile personal digital assistants, laptops, palmtops, netbooks, tablets and the like. These devices may include, apart from other components, a storage medium such as a flash memory, buffer, RAM, ROM and one or more computing devices. The computing devices associated with mobile devices may be enabled to execute program codes, methods, and instructions stored thereon.

Alternatively, the mobile devices may be configured to execute instructions in collaboration with other devices, such as a dedicated controller of the appliance. The mobile devices may communicate with the controller and configured to execute program codes.

The computer software, program codes, and/or instructions may be stored and/or accessed on computer readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks. Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The methods and/or systems useful in the present invention may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a computer readable medium.

The Application software may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, a method of the present invention may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The invention may be embodied in program instruction set executable on one or more computers. Such instructions sets may include any one or more of the following instruction types:

Data handling and memory operations, which may include an instruction to set a register to a fixed constant value, or copy data from a memory location to a register, or vice-versa, to store the contents of a register, result of a computation, or to retrieve stored data to perform a computation on it later, or to read and write data from hardware devices.

Arithmetic and logic operations, which may include an instruction to add, subtract, multiply, or divide the values of two registers, placing the result in a register, possibly setting one or more condition codes in a status register, to perform bitwise operations, e.g., taking the conjunction and disjunction of corresponding bits in a pair of registers, taking the negation of each bit in a register, or to compare two values in registers (for example, to see if one is less, or if they are equal).

Control flow operations, which may include an instruction to branch to another location in the program and execute instructions there, conditionally branch to another location if a certain condition holds, indirectly branch to another location, or call another block of code, while saving the location of the next instruction as a point to return to.

Coprocessor instructions, which may include an instruction to load/store data to and from a coprocessor, or exchanging with CPU registers, or perform coprocessor operations.

A processor of a computer of the present system may include “complex” instructions in their instruction set. A single “complex” instruction does something that may take many instructions on other computers. Such instructions are typified by instructions that take multiple steps, control multiple functional units, or otherwise appear on a larger scale than the bulk of simple instructions implemented by the given processor. Some examples of “complex” instructions include: saving many registers on the stack at once, moving large blocks of memory, complicated integer and floating-point arithmetic (sine, cosine, square root, etc.), SIMD instructions, a single instruction performing an operation on many values in parallel, performing an atomic test-and-set instruction or other read-modify-write atomic instruction, and instructions that perform ALU operations with an operand from memory rather than a register.

An instruction may be defined according to its parts. According to more traditional architectures, an instruction includes an opcode that specifies the operation to perform, such as add contents of memory to register—and zero or more operand specifiers, which may specify registers, memory locations, or literal data. The operand specifiers may have addressing modes determining their meaning or may be in fixed fields. In very long instruction word (VLIW) architectures, which include many microcode architectures, multiple simultaneous opcodes and operands are specified in a single instruction.

Some types of instruction sets do not have an opcode field (such as Transport Triggered Architectures (TTA) or the Forth virtual machine), only operand(s). Other unusual “0-operand” instruction sets lack any operand specifier fields, such as some stack machines including NOSC.

Conditional instructions often have a predicate field—several bits that encode the specific condition to cause the operation to be performed rather than not performed. For example, a conditional branch instruction will be executed, and the branch taken, if the condition is true, so that execution proceeds to a different part of the program, and not executed, and the branch not taken, if the condition is false, so that execution continues sequentially. Some instruction sets also have conditional moves, so that the move will be executed, and the data stored in the target location, if the condition is true, and not executed, and the target location not modified, if the condition is false. Similarly, IBM z/Architecture has a conditional store. A few instruction sets include a predicate field in every instruction; this is called branch predication.

The instructions constituting a program may be specified using their internal, numeric form (machine code); they may be specified using an assembly language or, more typically, may be generated from programming languages by compilers.

1. A computer for providing business-related information to a business entity, the computer comprising:
data input means configured to receive financial data of a business entity,
a first computer software algorithmic means configured to process financial data of the business entity, the algorithmic means configured to:
(i) identify a financial deficiency of the business entity,
(ii) identify electronic educational material relevant to the identified financial deficiency, and
(iii) instruct the computer, or a separate computer, to transmit electronic educational material relating to the identified financial deficiency to a computer of the business entity.

2. (canceled)

3. The computer of claim 1 wherein the first computer software algorithmic means is configured to instruct the computer, or a separate computer, to transmit the financial deficiency identified to the business entity.

4. The computer of claim 1 wherein the first computer software algorithmic means is configured to identify more than one financial deficiency, and the first computer software algorithmic means is configured to rank the deficiencies according to importance and/or magnitude.

5. The computer of claim 1 wherein the first computer software algorithmic means is configured to select one or more electronic educational materials by reference to one or more deficiencies identified.

6. The computer of claim 1 wherein the data input means is configured to receive data from a plurality of business entities.

7. The computer of claim 6 comprising data extraction means configured to extract the financial data of similar business entities from the financial data of a plurality of business entities for the purpose of benchmarking.

8. The computer of claim 6 comprising benchmark data calculation means configured to collate the financial data of similar business entities of the plurality of business entities and calculate benchmark financial data.

9. The computer of claim 8 comprising a second computer software algorithmic means configured to compare the financial data of a business entity of the plurality of business entities with the benchmark financial data.

10. The computer of claim 9 wherein the output of the second computer software algorithmic means is transmitted to a computer of the business entity of the plurality of business entities.

11. The computer of claim 9 comprising a third computer software algorithmic means configured to identify a financial deficiency of the business entity of the plurality of business entities by reference to the output of the comparison means.

12. The computer of claim 11 comprising a fourth computer software algorithmic means configured to select one or more electronic educational materials by reference to the deficiencies identified by the third computer software algorithmic means.

13. A system comprising the computer of claim 1 in data communication with (i) the computer of the business entity, or (ii) a computer of each of a plurality of business entities.

14. (canceled)

15. (canceled)

16. A computer-implemented method for providing business-related information to a business entity, the method comprising the steps of:
receiving financial data of a business entity into a computer,
processing the financial data by a first computer software algorithmic means configured to:
(i) identify a financial deficiency of the business entity,
(ii) identify electronic educational material relevant to the identified financial deficiency, and
(iii) instruct the computer, or a separate computer, to transmit electronic educational material relating to the identified financial deficiency to a computer of the business entity.

17. The method of claim 16 wherein the first computer software algorithmic means instructs the computer, or a separate computer, to transmit the financial deficiency identified to the business entity.

18. The method of claim 16 wherein the first computer software algorithmic means is configured to identify more than one financial deficiency, and the first computer software algorithmic means ranks the deficiencies according to importance and/or magnitude.

19. The method of claim 16 wherein the first computer software algorithmic means selects one or more electronic educational materials by reference to one or more deficiencies identified.

20. The method of claim 16 wherein the data input means is configured to receive data from a plurality of electronic databases comprising financial data of a plurality of business entities, and wherein the method comprises extracting the financial data of business entities from the financial data of a plurality of business entities for the purpose of benchmarking.

21. The method of claim 20 comprising extracting the financial data of similar business entities from the financial data of a plurality of business entities for the purpose of benchmarking.

22. The method of claim 21 comprising collating the financial data of the similar business entities of the plurality of business entities and calculating benchmark data.

23. (canceled)

24. (canceled)

25. (canceled)

26. (canceled)
